(19) United States
(12) Patent Application Publication
(10) Pub. No.: US 2009/0116816 A1
(43) Pub. Date: May 7, 2009

(54) CHAPTERING METHOD AND APPARATUS FOR MOVIE DATA

(76) Inventors: Kazushige HIROI, Machida (JP); Maki Furui, Tokyo (JP); Minako Toba, Mitaka (JP); Masayuki Oyamatsu, Yokohama (JP); Yoshitaka Hiramatsu, Sagamihara (JP); Tomochika Yamashita, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/265,792

(22) Filed: Nov. 6, 2008

(30) Foreign Application Priority Data
Nov. 7, 2007 (JP) 2007-289154

(51) Int. Cl. H04N 5/91; H04N 7/00

(52) U.S. Cl. 386/69; 348/468; 386/E05.001; 348/E07.001

(57) ABSTRACT

A chaptering apparatus and method for movie data to set chapter points at more appropriate points in the movie data are disclosed. The apparatus includes a unit for acquiring the subtitle data from the movie data and a unit for chaptering the movie data. The chaptering unit detects sections designated not to display text data in the subtitle data for predetermined time or longer, based on the subtitle data acquired by the subtitle data acquisition unit, and sets, as chapter starting points, ending points of sections designated not to display text data in the subtitle data for predetermined time or longer.

### INCORPORATION BY REFERENCE

The present application claims priority from Japanese application JP2007-289154 filed on Nov. 7, 2007, the content of which is hereby incorporated by reference into this application.

### BACKGROUND OF THE INVENTION

This invention relates to a chaptering apparatus for movie data and a chaptering method for movie data.

A method and apparatus for chaptering movie data are disclosed in, for example, JP-A-2000-354225 and JP-A-2000-354223 in which a chapter point is set at each tail end of a commercial message (CM) section detected by a CM detection method so that the CM sections can be skipped.

JP-A-2000-354225 and JP-A-2000-354223, in which the chapter point is set at the ending point of each CM section by the CM detection method as described above, poses the problem that the chapter point cannot be correctly set in the case where a CM is erroneously detected. Also, the ending point of the CM is not necessarily the proper point of chaptering the movie data. A chapter point may be often better set, for example, also at a position where the topics changes.

### SUMMARY OF THE INVENTION

This invention is intended to obviate this problem, and the object thereof is to provide a chaptering method and apparatus for movie data in which each chapter point is set at a more appropriate position in the movie data.

In order to achieve the aforementioned object, according to an aspect of the invention, there is provided a chaptering method and apparatus for movie data configured as described in, for example, the scope of the appended claims.

According to this invention, each chapter point is set at a more appropriate point in movie data. The viewer of the movie data, therefore, can watch the movie efficiently for chapter points thus set. Also, in the case where the movie to be watched by jumping for each chapter, the desired scene can be watched and not overlooked.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the hardware configuration for realizing the function blocks of a chaptering apparatus for movie data according to an embodiment of the invention.

FIG. 2 shows an example of a function block diagram of the chaptering apparatus for movie data according to an embodiment of the invention.

FIG. 3 shows an example of the data structure of the feature data according to an embodiment of the invention.

FIG. 4 shows an example of the data structure of the chapter data according to an embodiment of the invention.

FIG. 5 is a diagram for explaining a method of setting a chapter point by a chaptering block according to an embodiment of the invention.

### DESCRIPTION OF THE INVENTION

Embodiments of the invention are explained below with reference to the drawings.

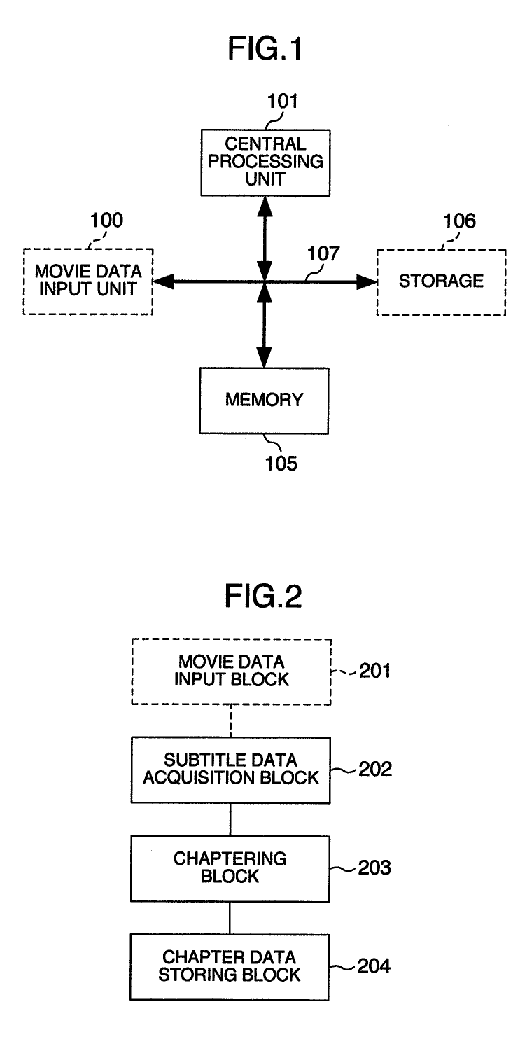

FIG. 1 shows an example of the hardware configuration of a chaptering apparatus for movie data according to this embodiment.

As shown in FIG. 1, the chaptering apparatus for movie data according to the embodiment includes a movie data input unit 100, a central processing unit 101, a memory 105 and/or a storage 106. These units are connected by a bus 107 and configured in such a manner that data can be transmitted to and received from each of the units.

The movie data input unit 100 inputs the movie data. The movie data input unit 100 may alternatively be a device for reading the movie data stored in the memory 105 or the storage 106. Also, in the case where the TV broadcasting is received, the movie data input unit 100 may be the TV tuner unit. The tuner unit includes, for example, a demodulation unit for demodulating the broadcast signal and a tuning unit for selecting the channel of the broadcast signal.

Also, in the case where the movie data is input through a network, the movie data input unit 100 can be a network card such as the LAN card. Incidentally, the chaptering apparatus for movie data according to the invention uses the subtitle data included in the movie data, and therefore, the movie data input unit 100 is not always required as long as the subtitle data can be acquired.

The central processing unit 101 is configured mainly of a microprocessor and executes the program stored in the memory 105 or the storage 106.

The memory 105 is implemented by, for example, a random access memory (RAM) or a read-only memory (ROM) and stores the program executed by the central processing unit 101, the data processed in this chaptering apparatus or the movie data to be played back and the chapter data generated in this chaptering apparatus.

The storage 106 is configured of, for example, a hard disk or a CD or DVD with the drive thereof or a nonvolatile memory such as a flash memory, and stores the program executed by the central processing unit 101, the data processed in this chaptering apparatus, the movie data to be played back or the chapter data generated in this chaptering apparatus. This storage 106 is not always required.

FIG. 2 is a function block diagram of the chaptering apparatus for movie data according to this embodiment. A part or the whole of these function blocks may be implemented by hardware added to the hardware shown in FIG. 2 or as a software program executed by the central processing unit 101. Incidentally, an explanation is made below about the software program by which all these function blocks are executed by the central processing unit 101.

As shown in FIG. 2, the chaptering apparatus for movie data is configured of a movie data input block 201, a subtitle acquisition block 202, a chaptering block 203 and a chapter data storing block 204.

In FIG. 2, the movie data input block 201 is supplied with the movie data to be chaptered, as described later, from the movie data input unit 100. The chaptering apparatus for movie data according to the invention uses the subtitle data included in the movie data, and therefore, the movie data input block 201 is not always required as long as the subtitle data can be acquired.

The subtitle acquisition block 202 acquires the subtitle data accompanying the movie data input by the movie data input block 201 and generates a table (called the feature data) including the presentation time stamp for the subtitle information and the types of the subtitle information.

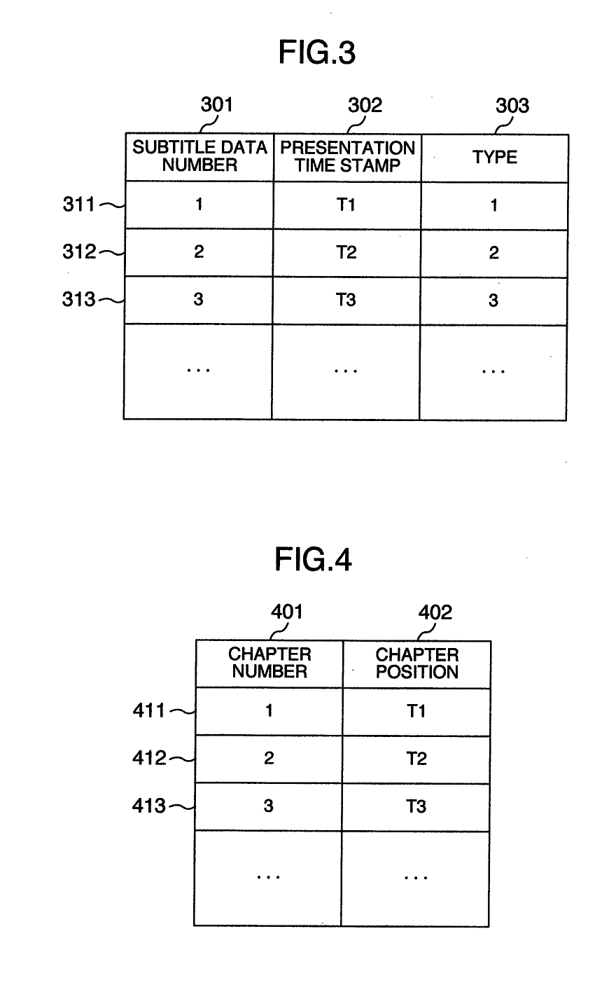

In the digital broadcasting, for example, the ES (Elementary Stream) of subtitles is sent like the voice ES and the video ES. This subtitle ES is acquired and decoded. The decoding result contains the subtitle information (which herein specifically indicates the information including the displayed text data in the subtitle data and the control code for controlling the display of the text data in the subtitle data) and the information on the presentation time stamp thereof. This operation can be realized, therefore, by writing the presentation time stamp and the type of the subtitle information in the table as shown in FIG. 3. Incidentally, the word “presentation” as used herein has the equal meaning as “display” in the case where the subtitle information contains the text data in the subtitle data to be displayed as subtitles.

FIG. 3 shows an example of the data structure of the feature data. In FIG. 3, reference numeral 301 designates the subtitle data numbers presented at the same time or at a time, and numerals 311 to 313 the subtitle information presented at a time, respectively. Numeral 302 designates the time when the particular subtitle information is presented, i.e. the presentation time stamp, and numeral 303 the type of the subtitle information presented at the particular time. The type of the subtitle information is expressed as “1” in the case where only the control code is included, 2″ in the case where the displayed text data in the subtitle data are included, and “3” in the case where the displayed text data in the subtitle data specifically includes “a mark of musical notation”.

Returning to FIG. 2, the chaptering block 203 sets the chapter point of the movie data using the feature data generated in the subtitle acquisition block 202 thereby to chapter the movie data. This is realized by, for example, generating the chapter data shown in FIG. 4.

FIG. 4 shows an example of the data structure of the chapter data generated by the chaptering block 203.

In FIG. 4, numeral 401 designates the chapter number, and numeral 402 designates at least one of the chapter positions which may be the time of the particular chapter in the movie data. Numerals 411, 413 each designate one chapter. In this case, three chapters are included.

Incidentally, the method of generating the chapter data in the chaptering block 203 is explained later.

Returning to FIG. 2, the chapter data storing block 204 holds chapter data generated in the chaptering block 203. This is realized by the configuration, for example, in which chapter data generated by the chaptering block 203 are stored in the memory 105 or the storage 106.

Next, the chaptering method by the chaptering block 203, i.e. the method of generating chapter data is explained.

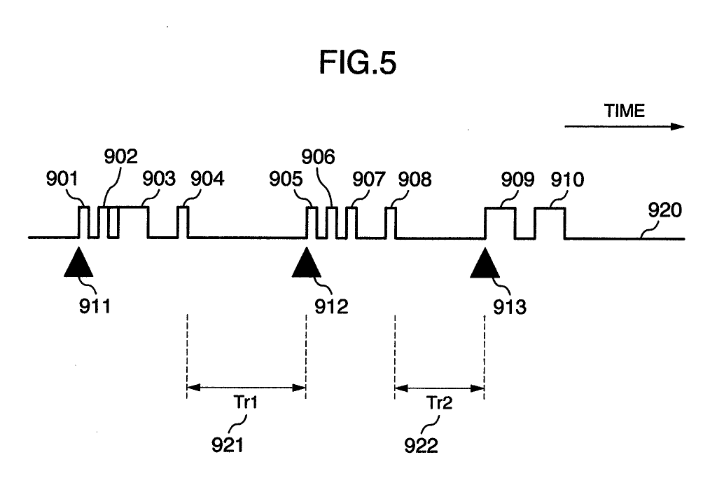

FIG. 5 is a diagram showing an example of the chaptering method in the chaptering block 203. In FIG. 5, numeral 920 designates a time chart showing the temporal relation for presentation of the subtitle information in the case where the feature data shown in FIG. 4 include the displayed text data in the subtitle data (i.e. type “2”) or in the case where the displayed text data in the subtitle data specifically include “a mark of the musical notation” (i.e. type “3”). Numerals 901 to 910 designate the timing at which these subtitle (type 2 or type 3 of) information are presented (displayed). Also, numerals 921, 922 designate the sections in which the subtitle information of type “2” or “3” is not displayed for a predetermined time (for example, 30 sec to 60 sec) or longer. Numerals 911 to 913 designate chapter points determined and set by the chaptering block 203. As shown in FIG. 5, the chaptering block 203 sets chapter points at temporal positions of the subtitle information of type “2” or “33” first presented. At the same time, the ending point of the section (Tr1 (921) or Tr2 (922) in FIG. 5) in which the subtitle information of type “2” or “3” presented is not displayed for a predetermined time (for example, between 30 seconds and 60 seconds inclusive) or longer is set as a chapter starting point (i.e. the chapter point). Thus, the movie data are chaptered by generating chapter data shown in FIG. 4 using the time stamp of the particular starting point. In the process, the chapter number 401 is determined in the ascending order starting with 1 as the serial number of chapters set in chronological order. Also, the chapter position 402 can be set as the time stamp at chapter start positions. This can be set, by acquiring from the feature data, the ending point of the section (Tr1 (921) and Tr2 (922) in FIG. 5) where the interval with subtitle information of type “2” or “3” presented therein is not displayed for a predetermined time (for example, 30 seconds to 60 seconds) or longer, i.e. the time when the subtitle information of type “2” or “31” is first presented.

In the chaptering apparatus for movie data according to the invention, therefore, the chapter point can be set at more appropriate positions for the movie data other than the CM ending point as compared with the CM detection method for setting the chapter point at the ending position of each CM sections.

It should be further understood by those skilled in the art that although the foregoing description has been made on embodiments of the invention, the invention is not limited thereto and various changes and modifications may be made without departing from the spirit of the invention and the scope of the appended claims.

1. A chaptering apparatus for movie data comprising:
a subtitle data acquisition unit for acquiring the subtitle data from the movie data; and
a chaptering unit, for chaptering the movie data based on the degree of frequency at which the acquired subtitle data to be displayed, appears.

2. The chaptering apparatus for movie data according to claim 1,
wherein the chaptering unit detects a section which is designated not to display the displayed text data in the subtitle data for a predetermined time or longer and configured of a plurality of continuous movie data, and sets the ending point of the section as a chapter starting point thereby to generate a new chapter.

3. The chaptering apparatus for movie data according to claim 2,
wherein the predetermined time is between 30 seconds and 60 seconds inclusive.

4. A chaptering method for movie data comprising the steps of:
acquiring the subtitle data from the movie data; and
chaptering the movie data by detecting a section designated not to display the text data in the subtitle data for a predetermined time or longer, based on the subtitle data acquired in the subtitle data acquisition step, and setting, as a chapter starting point, the ending point of the section designated not to display the displayed text data in the subtitle data for the predetermined time or longer.

5. The chaptering method for movie data according to claim 4,
wherein the chaptering step includes the step of detecting a section designated not to display the text data in the subtitle data for a predetermined time or longer, based on the subtitle data acquired in the subtitle data acquisition step, and the step of setting the ending point of the section as a chapter starting point.

6. The chaptering method for movie data according to claim 5,
wherein the predetermined time is between 30 seconds and 60 seconds inclusive.

7. An information apparatus for movie data, comprising:
an interface unit;
a processor coupled to the interface unit; and
a memory unit coupled to the processor;
wherein the processor receives the movie data through the interface unit, acquires the subtitle data from the movie data, and chapters the movie data based on the subtitle data thus acquired.

8. The information apparatus according to claim 7,
wherein the processor chapters the movie data based on the acquired subtitle data by detecting a section configured of a plurality of continuous movie data and designated not to display the text data in the subtitle data for a predetermined time or longer, sets, as a chapter starting point, the ending point of the section designated not to display the text data in the subtitle data for a predetermined time or longer, generates the chaptered data and stores the chaptered data in the memory unit.

9. The information apparatus according to claim 8,
wherein the predetermined time is between 30 seconds and 60 seconds inclusive.
